(19) United States
(12) Patent Application Publication
(10) Pub. No.: US 2003/0233464 A1
(43) Pub. Date: Dec. 18, 2003

(54) Priority progress streaming for quality-adaptive transmission of data

(76) Inventors: Jonathan Walpole, Beaverton, OR (US); Charles C. Krasic, Portland, OR (US)

Correspondence Address: IPSOLON LLP, 805 SW BROADWAY, #2740, PORTLAND, OR, 97205, US

(21) Appl. No.: 10/167,747

(22) Filed: Jun. 10, 2002

(51) Int. Cl. G06F 15/16

(52) U.S. Cl. 709/231

(57) ABSTRACT

A priority progress media-streaming system provides quality-adaptive transmission of multimedia in a shared heterogeneous network environment, such as the Internet. The system may include a server-side streaming media pipeline that transmits a stream of media packets that encompass a multimedia (e.g., video) presentation. Ones of the media packets correspond to a segment of the multimedia presentation that is transmitted based upon packet priority labeling and is out of time sequence from other media packets corresponding to the segment. A client side streaming media pipeline receives the stream of media packets, orders them in time sequence, and renders the multimedia presentation from the ordered media packets.

### Statement Regarding Federally Funded Research

This work supported in part through U.S. Department of Defense contract nos. N66001-97-C-8522 and N66001-00-2-8901. The U.S. Government has a paid-up license in this invention and the right in limited circumstances to require the patent owner to license others on reasonable terms as provided for by the terms these grants.

### FIELD OF THE INVENTION

The present invention relates to streaming transmission of data in a shared heterogeneous network environment, such as the Internet, and in particular relates to quality-adaptive streaming transmission of data in such an environment.

### BACKGROUND AND SUMMARY OF THE INVENTION

The Internet has become the default platform for distributed multimedia, but the computing environment provided by the Internet is problematic for streamed-media applications. Most of the well-known challenges for streamed-media in the Internet environment are consequences of two of its basic characteristics: end-point heterogeneity and best-effort service.

The end-point heterogeneity characteristic leads to two requirements for an effective streamed-media delivery system. First, the system must cope with the wide-ranging resource capabilities that result from the large variety of devices with access to the Internet and the many means by which they are connected.

Second, the system must be able to tailor quality adaptations to accommodate diverse quality preferences that are often task- and user-specific. A third requirement, due to best-effort service, is that streamed-media delivery should be able to handle frequent load variations.

Much of the research in the field of quality of service (QoS) is now concerned with addressing these requirements in the design of distributed multimedia systems. The term QoS is often used to describe both presentation level quality attributes, such as the frame-rate of a video (i.e., presentation QoS), and resource-level quality attributes, such as the network bandwidth (i.e., resource QoS).

The simplest approach to QoS scalability, used by many popular streamed-media applications, is to provide streamed-media at multiple predefined or “canned” quality levels. In this approach, end-host heterogeneity is addressed in the sense that a range of resource capabilities can be covered by the set of predefined levels, but the choice of quality adaptation policy is fixed. Furthermore, dynamic load variations are left to be managed by a client-side buffering mechanism.

Normally a buffering mechanism is associated with concealment of jitter in network latency. The buffering mechanism can also be used to conceal short-term bandwidth variations, if the chosen quality level corresponds to a bandwidth level at, or below, the average available bandwidth. In practice, this approach is too rigid. Client-side buffering is unable to conceal long-term variations in available bandwidth, which leads to service interruptions when buffers are overwhelmed.

From a user's perspective, interruptions have a very high impact on the utility of a presentation. To avoid interruption, the user must subscribe to quality levels that drastically under-utilize their typical resource capabilities. The canned approach is also difficult from the provider's perspective. Choosing which canned levels to support poses a problem because it is difficult for a provider to know in advance how best to partition their service capacities. The canned approach fails to solve problems imposed by best-effort service or heterogeneity constraints.

Recently, in search of Internet compatible solutions, re-searchers have begun to explore more-adaptive QoS-scalability approaches. (QoS scalability means the capability of a streamed-media system to dynamically trade-off presentation-QoS against resource-QoS.) There are two classes of such approaches. The first class, data rate shaping (DRS), performs some or all of the media encoding dynamically so that the target output rate of the encoder can be matched to both the end-host capabilities and the dynamic load characteristics of the network. The other class of approaches is based on layered transmission (LT), where media encodings are split into progressive layers and sent across multiple transmission channels.

The advantage of DRS is that it allows fine-grained QoS scalability, that is, it can adjust compression level to closely match the maximum available bandwidth. Since LT binds layers to transmission channels, it can only support coarse-grain QoS scalability. On the other hand, LT has advantages stemming from the fact that it decouples scaling from media-encoding. In LT, QoS scaling amounts to adding or removing channels, which is simple, and can be implemented in the network through existing mechanisms such as IP multicast. In stored-media applications, LT can perform the layering offline, greatly reducing the burden on media servers of supporting adaptive QoS-scalability.

A universal problem for QoS scalability techniques arises from the multi-dimensional nature of presentation-QoS. QoS dimensions for video presentations include spatial resolution, temporal resolution, color fidelity, etc. However, QoS scalability mechanisms such as DRS and LT expose only a single adaptation dimension, output rate in the case of DRS, or number of channels in the case of LT. The problem is mapping multi-dimensional presentation-QoS requirements into the single resource-QoS dimension. In both LT and DRS, the approach has been to either limit presentation-QoS adaptation to one dimension or to map a small number of presentation-QoS dimensions into resource QoS with ad-hoc mechanisms. DRS and LT provide only very primitive means for specification of QoS preferences.

Accordingly, the present invention provides quality-adaptive transmission of data, including multimedia data, in a shared heterogeneous network environment such as the Internet. A priority progress data-streaming system supports user-tailorable quality adaptation policies for matching the resource requirements of the data-streaming system to the capabilities of heterogeneous clients and for responding to dynamic variations in system and network loads. Although described with reference to streaming media applications such as audio and video, the present invention is similarly applicable to transmission of other types of streaming data such as sensor data, etc.

In one implementation, a priority progress media-streaming system includes a server-side streaming media pipeline that transmits a stream of media packets that encompass a multimedia (e.g., video) presentation. Multiple media packets corresponding to a segment of the multimedia presentation are transmitted based upon packet priority labeling and include time-stamps indicating the time-sequence of the packets in the segment. With the transmission being based upon the packet priority labeling, one or more of the media packets corresponding to the segment may be transmitted out of time sequence from other media packets corresponding to the segment. A client side streaming media pipeline receives the stream of media packets, orders them in time sequence, and renders the multimedia presentation from the ordered media packets.

A quality of service (QoS) mapper applies packet priority labeling to the media packets according to a predefined quality of service (QoS) specification that is stored in computer memory. The quality of service (QoS) specification defines packet priority labeling criteria that are applied by the quality of service (QoS) mapper. The predefined quality of service (QoS) specification may define packet priority labeling criteria corresponding to media temporal resolution, media spatial resolution, or both. The server-side streaming media pipeline includes a priority progress streamer that transmits the data or media packets based upon the applied packet priority labeling.

The present invention can provide automatic mapping of user-level quality of service specifications onto resource consumption scaling policies. Quality of service specifications may be given through utility functions, and priority packet dropping for layered media streams is the resource scaling technique. This approach emphasizes simple mechanisms, yet facilitates fine-grained policy-driven adaptation over a wide-range of bandwidth levels.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a block diagram of a computer-based priority progress media-streaming system for providing quality-adaptive transmission of multimedia in a shared heterogeneous network environment.

FIG. 2 is an illustration of a generalized data structure for a stream data unit (SDU) generated by quality of service mapper according to the present invention.

FIG. 3 is a schematic illustration of inter-frame dependencies characteristic of the MPEG encoding format for successive video frames.

FIG. 4 is a block diagram illustrating a priority progress control mechanism.

FIGS. 5 and 6 are schematic illustrations of the operation of an upstream adaptation buffer at successive play times.

FIGS. 7 and 8 are schematic illustrations of the operation of a downstream adaptation buffer at successive play times.

FIG. 9 is a schematic illustration of successive frames with one or more layered components for each frame.

FIGS. 10A-10C are schematic illustrations of prioritization of layers of a frame-based data type.

FIG. 11 is a generalized illustration of a progress regulator regulating the flow of stream data units in relation to a presentation or playback timeline.

FIG. 12 is an operational block diagram illustrating operation of a priority progress transcoder.

FIG. 13 is an illustration of a partitioning of data from MPEG (DCT) blocks.

FIG. 14 is an operational block diagram illustrating priority progress transcoding.

FIG. 15 is a graph 320 illustrating a general form of a utility function for providing a simple and general means for users to specify their preferences.

FIGS. 16A and 16B are respective graphs 330 and 340 of exemplary utility functions for temporal resolution and spatial resolution in video, respectively.

FIG. 16 is a flow diagram of a QoS mapping method for translating presentation QoS requirements.

FIGS. 18A and 18B are graphs of exemplary utility functions for temporal resolution and spatial resolution in video, respectively.

### DETAILED DESCRIPTION OF PREFERRED EMBODIMENTS

FIG. 1 is a block diagram of a computer-based priority progress data-streaming system 100 for providing quality-adaptive transmission of data (e.g., multimedia data) in a shared heterogeneous network environment, such as the Internet. Priority progress data-streaming system 100 supports user-tailorable quality adaptation policies for matching the resource requirements of data-streaming system 100 to the capabilities of heterogeneous clients and for responding to dynamic variations in system and network loads.

Priority progress data-streaming system 100 is applicable to transmission of any type of streaming data, including audio data and video data (referred to generically as multimedia or media data), sensor data, etc. For purposes of illustration, priority progress data-streaming system 100 is described with reference to streaming media applications and so is referred to as priority progress media-streaming system 100. It will be appreciated, however, that the following description is similarly applicable to priority progress data-streaming system 100 with streaming data other than audio or video data.

Priority progress media-streaming system 100 may be characterized as including a server-side media pipeline 102 (sometimes referred to as producer pipeline 102) and a client-side media pipeline 104 (sometimes referred to as consumer pipeline 104). Server-side media pipeline 102 includes one or more media file sources 106 for providing audio or video media.

For purposes of description, media file sources 106 are shown and described as MPEG video sources, and priority progress media-streaming system 100 is described with reference to providing streaming video. It will be appreciated, however, that media file sources 106 may provide audio files or video files in a format other than MPEG, and that priority progress media-streaming system 100 is capable of providing streaming audio, as well as streaming video.

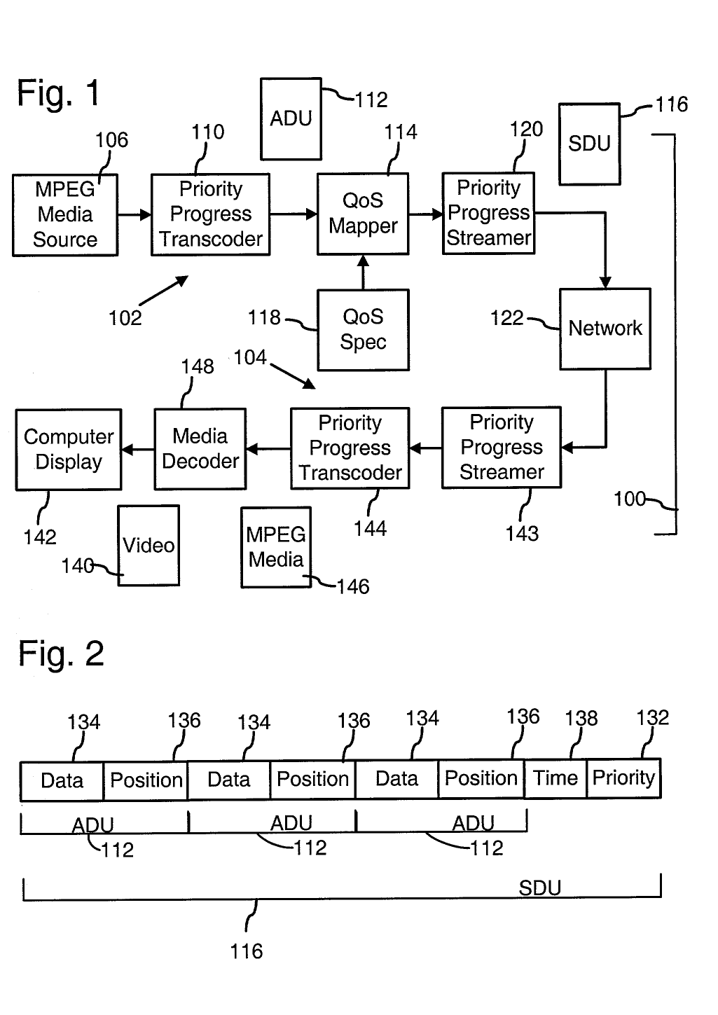

A priority progress transcoder 110 receives one or more conventional format (e.g., MPEG-1) media files and converts them into a corresponding stream of media packets that are referred to as application data units (ADUs) 112. A quality of service (QoS) mapper 114 assigns priority labels to time-ordered groups of application data units (ADUs) 112 based upon a predefined quality of service (QoS) policy or specification 118 that is held in computer memory, as described below in greater detail. Quality of service (QoS) mapper 114 also assigns time-stamps or labels to each application data unit (ADU) 112 in accordance with its time order in the original media or other data file. Each group of application data units (ADUs) 112 with an assigned priority label is referred to as a stream data unit (SDU) 116 (FIG. 2).

A priority progress streamer 120 sends the successive stream data units (SDUs) 116 with their assigned priority labels and time-stamp labels over a shared heterogeneous computer network 122 (e.g., the Internet) to client-side media pipeline 104. Priority progress streamer 120 sends the stream data units (SDUs) 116 in an order or sequence based upon decreasing priority to respect timely delivery and to make best use of bandwidth on network 122, thereby resulting in re-ordering of the SDUs 116 from their original time-based sequence. In one implementation of a streaming media format described in relation to MPEG video, the stream data units (SDUs) 116 are sometimes referred to as being either SPEG data or of an SPEG format. It will be appreciated, however, that the present invention can be applied to any stream of time- and priority-labelled packets regardless of whether or not the packets correspond to audio or video content.

FIG. 2 is an illustration of a generalized data structure 130 for a stream data unit (SDU) 116 generated by quality of service mapper 114. Stream data unit (SDU) 116 includes a group of application data units (ADUs) 112 with a packet priority label 132 that is applied by quality of service mapper 114. Each application data unit 112 includes a media data segment 134 and a position 136 corresponding to the location of the data segment 134 within the original data stream (e.g. SPEG video). The time stamp 138 of each stream data unit (SDU) 116 corresponds to the predefined time period or window that encompasses the positions 136 of the application data units (ADUs) 112 in the stream data unit (SDU) 116.

Several ADUs 112 may belong to the same media play time 138. These ADUs 112 are separated from each other because they contribute incremental improvements to quality (e.g. signal-to-noise ratio (SNR) improvements). The QoS mapper 114 will group these ADUs 112 back together in a common SDU 116 if, as a result of the prioritization specification, it is determined that the ADUs 112 should have the same priority. The position information is used later by the client side to re-establish the original ordering.

With reference to FIG. 1, client-side media pipeline 104 functions to obtain from the received successive stream data units (SDUs) 116 a decoded video signal 140 that is rendered on a computer display 142. Client-side media pipeline 104 includes a priority progress streamer 143 and a priority progress transcoder 144. Priority progress streamer 143 receives the stream data units (SDUs) 116, identifies the application data units (ADUs) 112, and re-orders them in time-based sequence according to their positions 136. Priority progress transcoder receives the application data units (ADUs) from the streamer 143 and generates one or more conventional format (e.g. MPEG-1) media files 146. A conventional media decoder 148 (e.g., a MPEG-1 decoder) generates the decoded video 140 from the media files 146.

It is noted that priority progress streamer 120 might not send all stream data units (SDUs) 116 corresponding to source file 106. Indeed, an aspect of the present invention is that priority progress streamer 120 sends, or does not send, the stream data units (SDUs) 116 in an order or sequence based upon decreasing priority. Hence a quality adaptation is provided by selectively dropping priority-labeled stream data units (SDUs) 116 based upon their priorities, with lower priority stream data units (SDUs) 116 being dropped in favor of higher priority stream data units (SDUs) 116.

Client-side media pipeline 104 only receives stream data units (SDUs) 116 that are sent by priority progress streamer 120. As a result, the decoded video 140 is rendered on computer display 142 with quality adaptation that can vary to accommodate the capabilities of heterogeneous clients (e.g., client-side media pipeline 104) and dynamic variations in system and network loads. The packet priority labels 132 of the application data units (ADUs) 112 allow quality to be progressively improved given increased availability of any limiting resource, such as network bandwidth, processing capacity, or storage capacity. Conversely, the packet priority labels 132 can be used to achieve graceful degradation of the media rendering, or other streamed file transfer, as the availability of any transmission resource is decreased. In contrast, the effects of packet dropping in conventional media streams are non-uniform, and can quickly result in an unacceptable presentation.

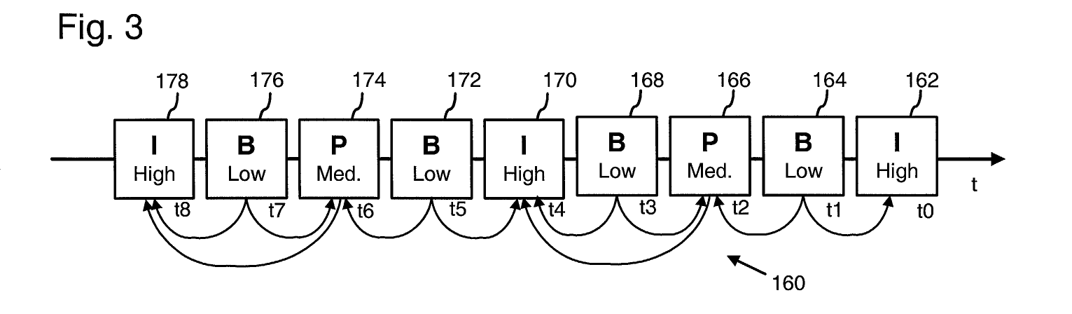

FIG. 3 is a schematic illustration of inter-frame dependencies 160 characteristic of the MPEG encoding format for successive video frames 162-170 at respective times t0-t8. It will be appreciated that video frames 162-170 are shown with reference to a time t indicating, for example, that video frame 162 occurs before or is previous to video frame 170. The sequence of video frames illustrated in FIG. 3 illustrate an example of a MPEG group of pictures (GoP) pattern, but many different group of pictures (GoP) patterns may be used in MPEG video. as is known in the art.

The arrows in FIG. 3 indicate the directions of “depends-on” relations in MPEG decoding. For example, the arrows extending from video frame 176 indicate that decoding of it depends on video information in frames 174 and 178. “I” frames have intra-coded picture information and can be decoded independently (i.e., without dependence on any other frame). Video frames 162, 170, and 178 are designated by the reference “I” to indicate that intra-coded picture information from those frames is used in their respective MPEG encoding.

Each “P” frame depends on the previous “I” or “P” frame (only previous “I” frames are shown in this implementation), so a “P” frame (e.g., frame 174) cannot be decoded unless the previous “I” or “P” frame is present (e.g., frame 178). Video frames 166 and 174 are designated by the reference “P” to indicate that they are predictive inter-coded frames.

Each “B” frame (e.g., frame 168) depends on the previous “I” frame or “P” frame (e.g., frame 170), as well as the next “I” frame or “P” frame (e.g., frame 166). Hence, each “B” frame has a bi-directional dependency so that a previous frame and a frame later in the time series must be present before a “B” frame can be decoded. Video frames 164, 168, 172, and 176 are designated by the reference “B” to indicate that they are bi-predictive inter-coded frames.

In the illustration of FIG. 3, “I” frames 162, 170, and 178 are designated as being of high priority, “P” frames 166 and 174 are designated as being of medium priority, and “B” frames 172 and 176 are designated as being of low priority, as assigned by quality of service mapper 114. It will be appreciated, however, that these priority designations are merely exemplary and that priority designations could be applied in a variety of other ways.

For example, “I” frames are not necessarily the highest priority frames in a stream even though “I” frames can be decoded independently of other frames. Since other frames within the same group of pictures (GoP) depend on them, an “I” frame will typically be of priority that is equal to or higher than that any other frame in the GoP. Across different groups of pictures (GoPs), an “I” frame in one GoP may be of a lower priority than a “P” frame in another GoP, for example. Such different priorities may be assigned based upon the specific utility functions in quality of service specification 118 (FIG. 1) provided to quality of service mapper 114 (FIG. 1).

Similarly, even though no other frames depend on them and they can be dropped without forcing the dropping of other frames, “B” frames make up half or more of the frames in an MPEG video sequence and can have a large impact on video quality. As a result, “B” frames are not necessarily the lowest priority frames in an MPEG stream. Accordingly, a “B” frame will typically have no higher a priority than the specific “I” and “P” frames on which the “B” frame depends. As examples, a “B” frame could have a higher priority than a “P” frame in the same GoP, and even higher than an “I” frame in another GoP. As indicated above, such different priorities may be assigned based upon the specific utility functions in quality of service specification 118 provided to quality of service mapper 114.

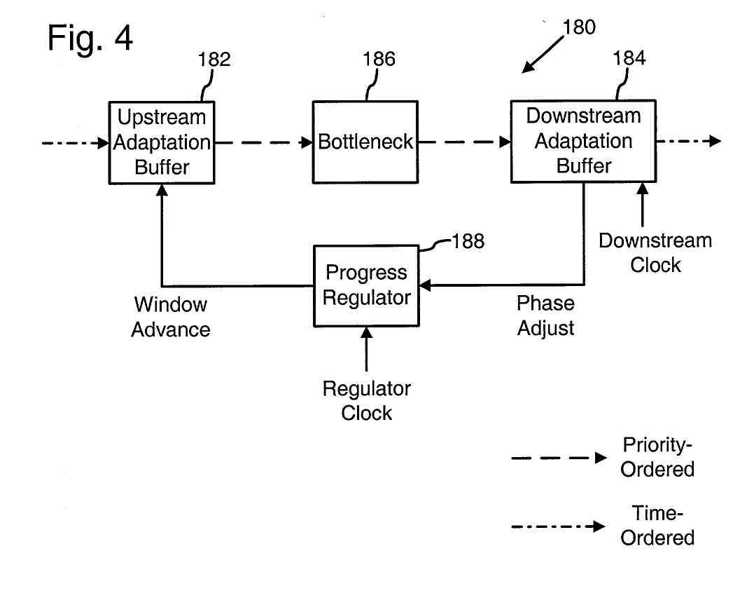

FIG. 4 is a block diagram illustrating priority progress control mechanism 180 having an upstream adaptation buffer 182 and a downstream adaptation buffer 184 positioned on opposite sides of a pipeline bottleneck 186. A progress regulator 188 receives from downstream adaptation buffer 184 timing feedback that is used to control the operation of upstream adaptation buffer 182. With regard to FIG. 1, for example, adaptation buffer 182 and progress regulator 188 could be included in priority progress streamer 120, and adaptation buffer 184 could be included in priority progress transcoder 144. Bottleneck 186 could correspond to computer network 122 or to capacity or resource limitations at either the server end or the client end.

Accordingly, that priority progress control mechanism 180 could similarly be applied to other bottlenecks 186 in the transmission or decoding of streaming media. For example, conventional media decoder 148 could be considered a bottleneck 186 because it has unpredictable progress rates due both to data dependencies in MPEG and to external influences from competing tasks in a multi-tasking environment.

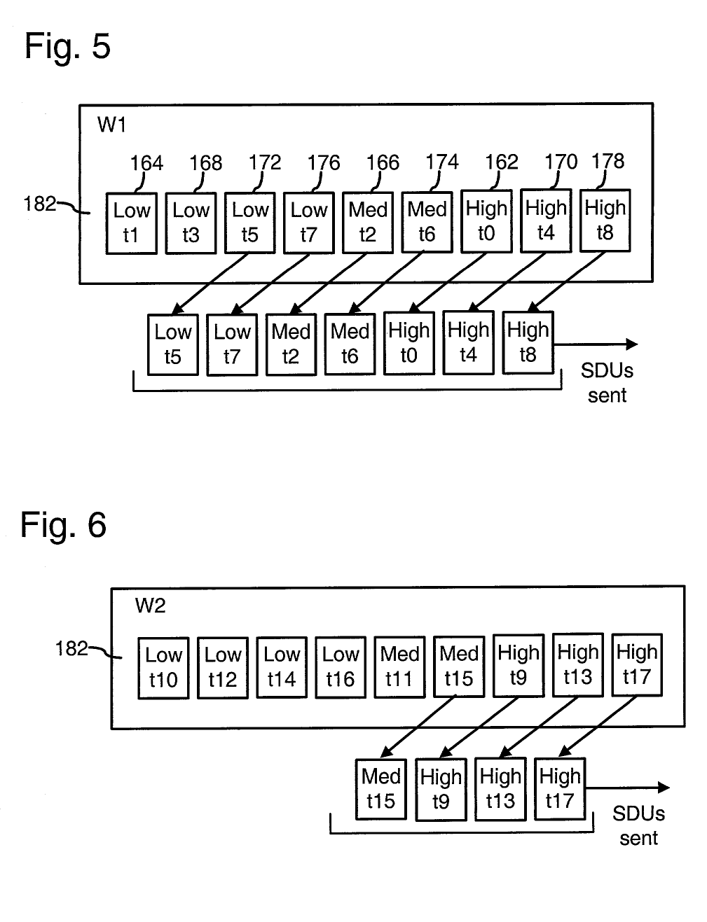

FIGS. 5 and 6 are schematic illustrations of the operation of upstream adaptation buffer 182 at successive play time windows W1 and W2 with respect to a succession of time- and priority-labeled stream data units (SDUs). For purposes of illustration, the time- and priority-labeled stream data units (SDUs)correspond to video frames used in MPEG encoding and described with reference to FIG. 3. For purposes of consistency, the priority-labeled stream data units (SDUs) of FIG. 5 bear the reference numerals corresponding to the video frames of FIG. 3, and the priority-labeled stream data units (SDUs) of FIG. 6 bear time notations corresponding to a next successive set of video frames. It will be appreciated, however, that in the present invention the time- and priority-labeled stream data units (SDUs) may each include multiple frames of video information or one or more segments of information in a video frame. Likewise, the time- and priority-labeled stream data units (SDUs) may include information or data other than video or audio media content.

With reference to FIGS. 3-6, progress regulator 188 defines an upstream adaptation time window and slides or advances it relative to the priority-labeled stream data units (SDUs) for successive, non-overlapping time periods or windows. Upstream adaptation buffer 182 admits in priority order all the priority-labeled stream data units (SDUs) within the boundaries of the upstream time window (e.g., time period t0-t8 in FIG. 5). The priority-labeled stream data units (SDUs) flow from upstream adaptation buffer 182 in priority-order through bottleneck 186 to downstream adaptation buffer 184 as quickly as bottleneck 186 will allow.

With each incremental advance of the upstream time window by progress regulator 188 to a successive time period, the priority-labeled stream data units (SDUs) not yet sent from upstream adaptation buffer 182 are expired and upstream adaptation buffer 182 is populated with priority-labeled stream data units (SDUs) of the new position. In the play time window W1 of FIG. 5, for example, priority-labeled stream data units (SDUs) for time units t8, t4, t0, t6, t2, t7, and t5 are sent in priority order and the remaining priority-labeled stream data units (SDUs) in upstream adaptation buffer 182 (i.e., the SDUs at t₃ and t1) are expired.

FIG. 6 illustrates that in a next successive play time window W2 upstream adaptation buffer 182 admits in priority order all the priority-labeled stream data units (SDUs) within the boundaries of the upstream time window (e.g., next successive time periods t9-t17 in FIG. 6). The priority-labeled stream data units (SDUs) flow from upstream adaptation buffer 182 in priority-order so the priority-labeled stream data units (SDUs) for time units t17, t13, t9, and t15 are sent in priority order and the remaining priority-labeled stream data units (SDUs) in upstream adaptation buffer 182 (i.e., the SDUs at t11, t16, t14, t12, and t10) are expired. Upstream adaptation buffer 182 operates, therefore, as a priority-based send queue.

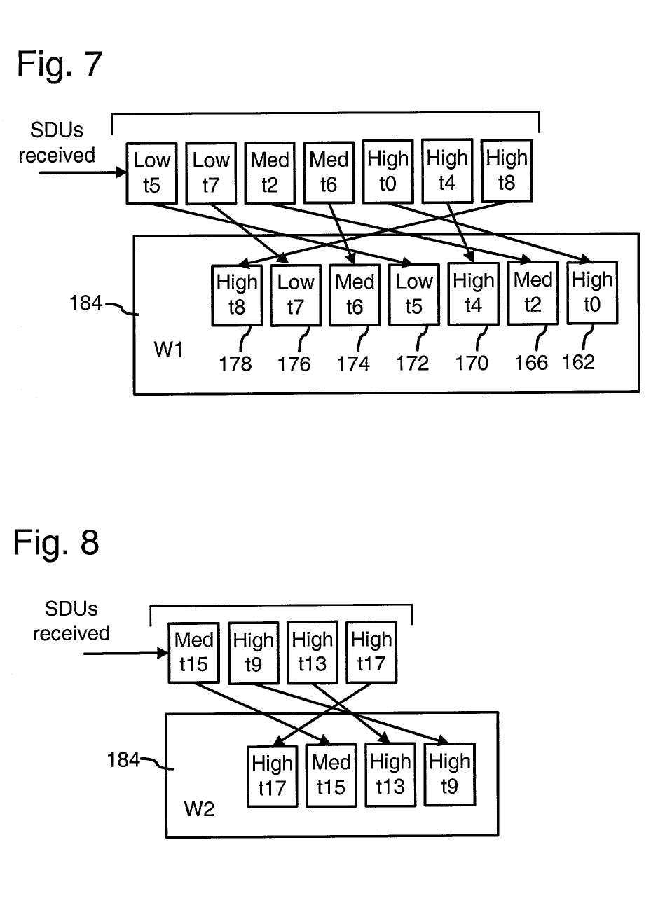

FIGS. 7 and 8 are schematic illustrations of the operation of downstream adaptation buffer 184 corresponding to successive play time windows W1 and W2 with respect to the succession of priority-labeled stream data units (SDUs) of FIGS. 5 and 6, respectively. With reference to FIGS. 4, 7, and 8, progress regulator 188 defines a downstream adaptation time window and slides or advances it relative to the priority-labeled stream data units (SDUs) for successive, non-overlapping time periods or windows.

The downstream adaptation buffer 184 collects the time- and priority-labeled stream data units (SDUs) and re-orders them according to timestamp order, as required. In one implementation, downstream adaptation buffer 184 re-orders the stream data units (SDUs) independently of and without reference to their priority labels. The stream data units (SDUs) are allowed to flow out from the downstream buffer 184 to a media decoder 148 when it is known that no more SDUs for time window (e.g., W1 or W2) will be timely received. Downstream adaptation buffer 184 admits all the priority-labeled stream data units (SDUs) received from upstream adaptation buffer 182 via bottleneck 186 within the boundaries of the time window.

In time window W1 of FIG. 7, for example, the priority-ordered stream data units (SDUs) of FIG. 5 are received. Downstream buffer 184 re-orders the received stream data units (SDUs) into time-sequence (e.g., t0, t2, t4, t5, t6, t7, t8) based upon the time stamps labels of the stream data units (SDUs). The time-ordered stream data units (SDUs) then flow to media decoder 148. In time window W2 of FIG. 8, for example, the priority-labeled stream data units (SDUs) of FIG. 6 are received and are re-ordered into time sequence (e.g., t9, t13, t15, and t17) based upon the time stamps or labels of the stream data units (SDUs).

The exemplary implementation described above relates to a frame-dropping adaptation policy. As indicated above, the time- and priority-labeled stream data units (SDUs) may each include one or more segments or layers of information in a video frame so that a layer-dropping adaptation policy can be applied, either alone or with a frame-dropping adaptation policy.

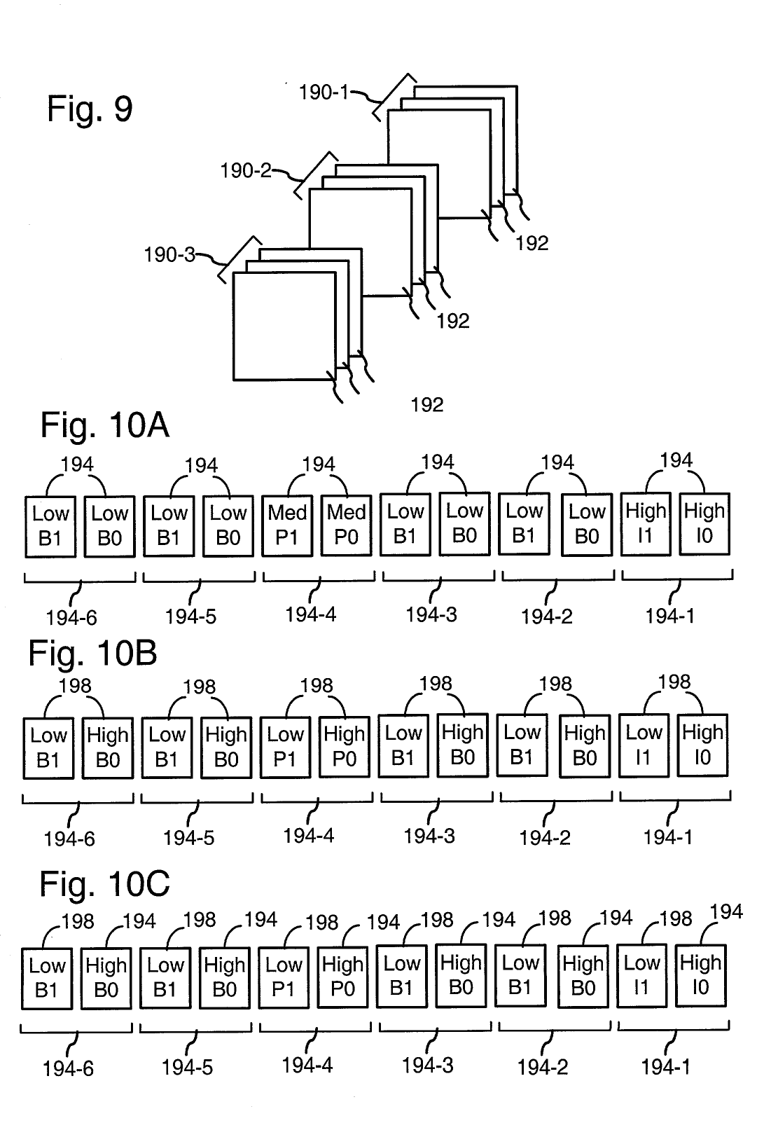

FIG. 9 is a schematic illustration of successive frames 190-1, 190-2, and 190-3 with one or more components of each frame (e.g., picture signal-to-noise ratio, resolution, color, etc.) represented by multiple layers 192. Each layer 192 may be given a different priority, with a high priority being given to the base layer and lower priorities being given to successive extension layers.

FIGS. 10A-10C are schematic illustrations of prioritization of layers of a frame-based data type. FIG. 10A illustrates a layered representation of frames 194 for a frame-dropping adaptation policy in which each frame 194 is represented by a pair of frame layers 196. Frames 194 are designated as “I,” “P,” and “B” frames of an arbitrary group of pictures (GoP) pattern in an MPEG video stream. In this illustration, both frame layers 196 of each frame 194 are assigned a common priority.

FIG. 10B illustrates a layered representation of frames 194 for a signal-to-noise ratio (SNR)-dropping adaptation policy in which each frame 194 is represented by a pair of SNR layers 198. Frames 194 are designated as “I,” “P,” and “B” frames of the same arbitrary group of pictures (GoP) pattern as FIG. 10A. In this illustration, the two SNR layers 1-98 of each frame 194 are assigned a different priority, with the base layers (designated by the suffix “0”) being assigned a higher priority than the extension layer (designated by the suffix “1”).

FIG. 10C illustrates a layered representation of frames 194 for a mixed frame- and SNR-dropping adaptation policy in which each frame 194 is represented by a frame base layer 196 and an SNR extension layer 198. Frames 194 are designated as “I,” “P,” and “B” frames of the same arbitrary group of pictures (GoP) pattern as FIG. 10A. In this illustration, the frame base layer 196 (designated by the suffix “0”) of each frame 194 is assigned a priority equal to or higher than the priority of the SNR extension layer 196 (designated by the suffix “1”).

FIGS. 10A-10C illustrate that the prioritization of packets according to the present invention supports tailorable multi-dimensional scalability. This type of implementation can provide for a common time stamp multiple stream data units (SDUs) that can be sent at different times.

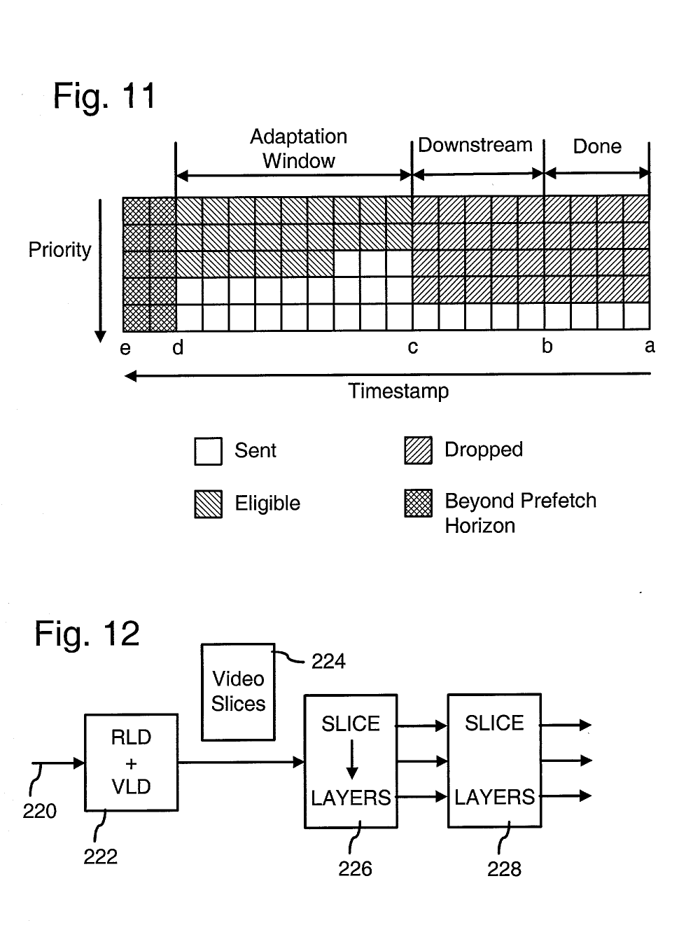

FIG. 11 is a generalized illustration of progress regulator 188 regulating the flow of SDUs in relation to a presentation or playback timeline. The timeline is based on the usual notion of normal play time, where a presentation is thought to start at time zero (epoch a) and run to its duration (epoch e). Once started, the presentation time (epoch b) advances at some rate synchronous with or corresponding to real-time.

The SDUs within the adaptation window in the timeline correspond to the contents of upstream and downstream adaptation buffers 182 and 184. The SDUs that are within the adaptation window that are sent are either in bottleneck 186 or the downstream buffer 184. The SDUs that are still eligible are in the upstream buffer 182.

The interval spanned by the adaptation window provides control over the responsiveness-stability trade-off of quality adaptation. The larger the interval of the adaptation window, the less responsive and the more stable quality will be. A highly responsive system is generally required at times of interactive events (start, fast-forward, etc.), while stable quality is generally preferable.

Transitions from responsiveness to stability are achieved by progressively expanding the size or duration of the adaptation window. The progress regulator 188 can manipulate the size of the adaptation window through actuation of the ratio between the rate at which the adaptation window is advanced and the rate at which the downstream clock (FIG. 4) advances. By advancing the timeline faster than the downstream clock (ratio>1), progress regulator 188 can expand the adaptation window with each advancement, skimming some current quality in exchange for more stable quality later, as described in greater detail below.

SPEG Data

One of the key parameters governing the compression rate in conventional MPEG encoders is the quantization level, which is the number of low-order bits dropped from the coefficients of the frequency domain representation of the image data. The degree to which an MPEG video encoder can quantize is governed by the trade-off between the desired amount of compression and the final video quality. Too much quantization leads to visible video artifacts. In standard MPEG-1 video, the quantization levels are fixed at encode time.

In contrast, the video in SPEG is layered by iteratively increasing the quantization by one bit per layer. At run time, quantization level may be adjusted on a frame-by-frame basis. Scalable encoding allows transmission bandwidth requirements to be traded against quality. As a side-effect of this trade-off, the amount of work done by the decoding process would also typically reduce as layers are dropped since the amount of data to be processed is reduced. Scalable encodings often take a layered approach, where the data in an encoded stream is divided conceptually into layers. A base layer can be decoded into presentation form with a minimum level of quality. Extended layers are progressively stacked above the base layer, each corresponding to a higher level of quality in the decoded data. An extended layer requires lower layers to be decoded to presentation form.

Rather than constructing an entirely new encoder, our approach is to transcode MPEG-1 video into the SPEG layering. Transcoding has lower compression performance than a native approach, but is easier to implement than developing a new scalable encoder. It also has the benefit of being able to easily use existing MPEG videos. For stored media, the transcoding is done offline. For live video the transcoding can be done online.

FIG. 12 is an operational block diagram illustrating in part operation of priority progress transcoder 110. Original MPEG-1 video is received at an input 220. Operational block 222 indicates that the original MPEG-1 video is partially decoded by parsing video headers, then applying inverse entropy coding (VLD+RLD), which includes inverse run-length coding (RLD) and inverse variable-length Huffman (VLD) coding. Operational block 222 produces video “slices” 224, which in MPEG video contain sequences of frequency-domain (DCT) coefficients. Operational block 226 indicates that data from the slices 224 is partitioned into layers. Operational block 228 indicates that run-length encoding (RLE) and variable-length Huffman (VLC) coding (RLE+VLC) are re-applied to provide SPEG video.

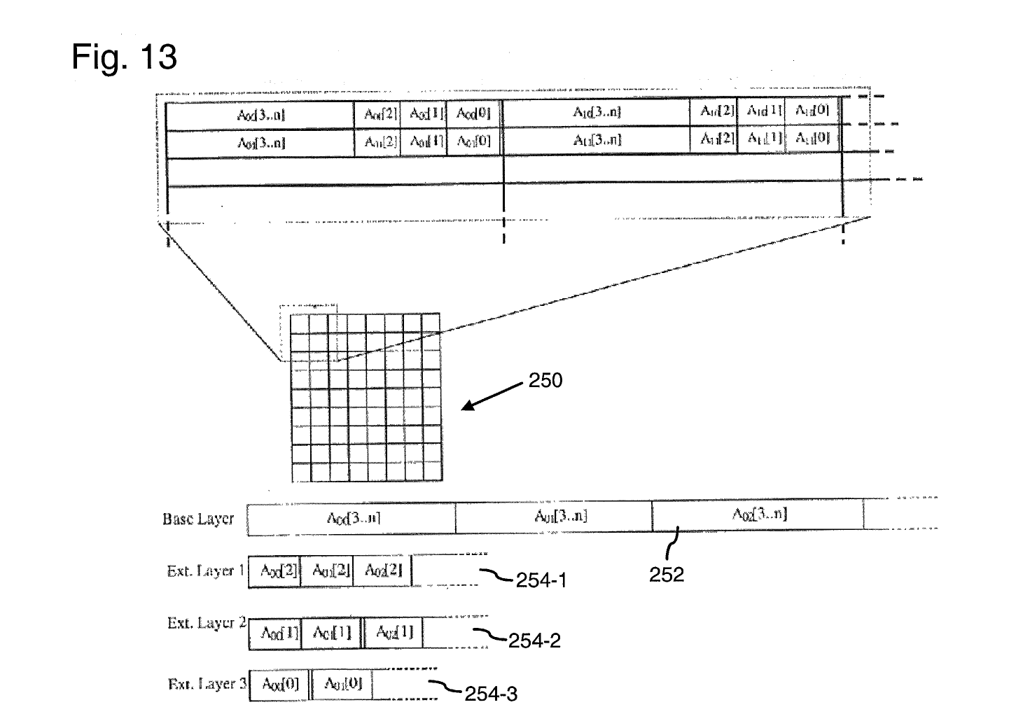

FIG. 13 is an illustration of a partitioning of data from MPEG (DCT) blocks 250 among a base SPEG layer 252 and extension SPEG layers 254. MPEG blocks 250 are 8×8 blocks of coefficients that are obtained by application of a two-dimensional discrete-cosine transform (DCT) to 8×8 blocks of pixels, as is known in the art

With n-number of SPEG layers 252 and 254, a base layer 252 is numbered 0 and successively higher extension layers 254-1 to 254-(n−1) are numbered 1 to n−1, respectively. A DCT block in the lowest extension layer 254-1 is coded as the difference between the corresponding original MPEG DCT block 250, and the original block 250 with one bit of precision removed.

Generalizing this approach, each (n-k)-numbered SPEG extension layer 254 is coded as the difference between the original MPEG (DCT) block 250 with k bits removed and the original MPEG (DCT) block 250 with k−1 bits removed. The base layer 252 is coded as the original MPEG (DCT) block 250 with n−1 bits removed. It is noted that extension layers 254 are differences while base layer 252 is not. Once layered in this manner, entropy coding is re-applied. One operating implementation uses one base layer 252 and three extension layers 254. It will be appreciated, however, that any non-zero number of extension layers 254 could be used.

In one implementation, partitioning of SPEG data occurs at the MPEG slice level. All header information from the original MPEG slice goes unchanged into the SPEG base layer slice, along with the base layer DCT blocks. Extension slices contain only the extension DCT block differentials. The SPEG to MPEG transcode that returns the video to standard MPEG format is performed as part of the streamed-media pipeline and includes the same steps as the MPEG to SPEG transcoding, only in reverse.

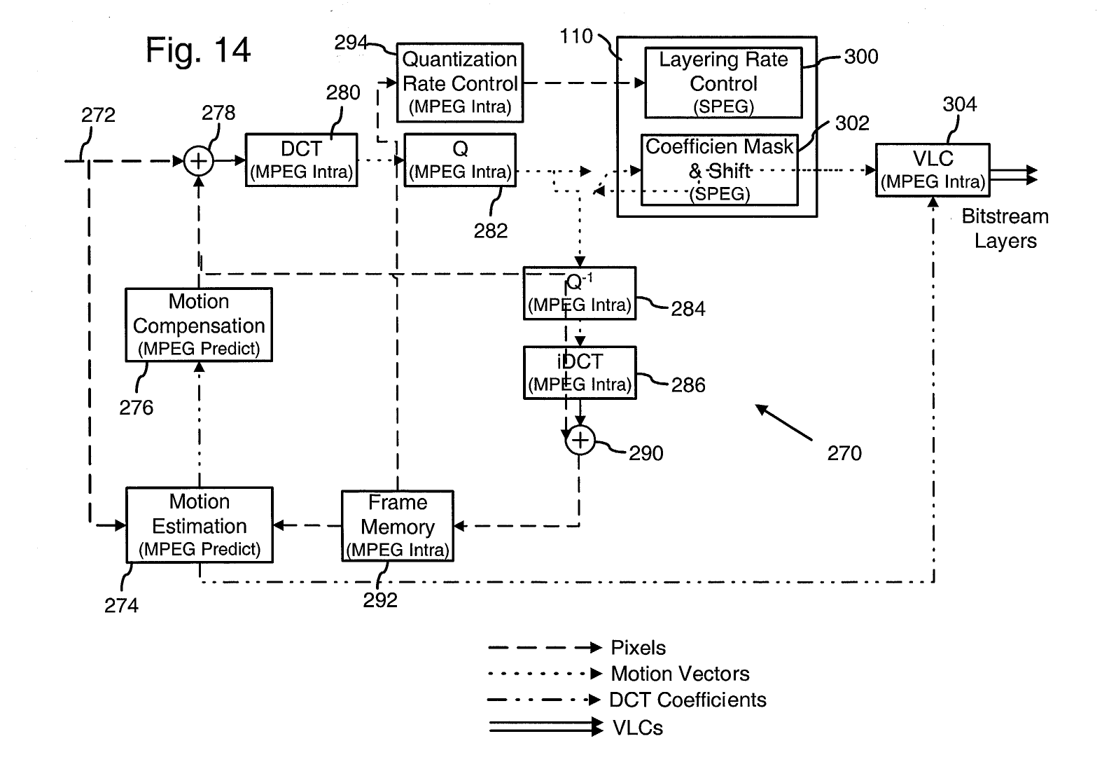

FIG. 14 is an operational block diagram illustrating priority progress transcoding 270 with regard to raw input video 272. Accordingly, priority progress transcoding 270 includes conventional generation of MPEG components in combination with transcoding of the MPEG components into SPEG components.

Input video 272 in the form of pixel information is delivered to a MPEG motion estimation processor 274 that generates MPEG predictive motion estimation data that are delivered to a MPEG motion compensation processor 276. An adder 278 delivers to a discrete-cosine transform (DCT) processor 280 a combination of the input video 272 and pixel-based predictive MPEG motion compensation data from MPEG motion compensation processor 276.

DCT processor 280 generates MPEG intra-frame DCT coefficients that are delivered to a MPEG quantizer 282 for MPEG quantization. Quantized MPEG intra-frame DCT coefficients are delivered from MPEG quantizer 282 to priority progress transcoder 110 and an inverse MPEG quantizer 284.

In connection with the MPEG processing, an inverse discrete-cosine transform (iDCT) processor 286 is connected to inverse MPEG quantizer 284 and generates inverse-generated intra-frame pixel data that are delivered to an adder 290, together with pixel-based predictive MPEG motion compensation data from MPEG motion compensation processor 276. Adder 290 delivers to a frame memory 292 a combination of the inverse-generated pixel data and the pixel-based predictive MPEG motion compensation data from MPEG motion compensation processor 276. Frame memory 292 delivers pixel-based frame data to MPEG motion estimation processor 274 and a MPEG quantization rate controller 294.

Priority progress transcoder 110 includes a layering rate controller 300 and a coefficient mask and shift controller 302 that cooperate to form SPEG data. Coefficient mask and shift controller 302 functions to iteratively remove one bit of quantization from the DCT coefficients in accordance with layering data provided by layering rate controller 300. A variable length Huffman encoder 304 receives the SPEG data generated by transcoder 110 and motion vector information from MPEG motion estimation processor 274 to generate bitstream layers that are passed to quality of service (QoS) mapper 114. As described below in greater detail, quality of service (QoS) mapper 114 generates successive stream data units (SDUs) 116 (FIG. 2) based upon predefined QoS policy or specification 118.

QoS Specification

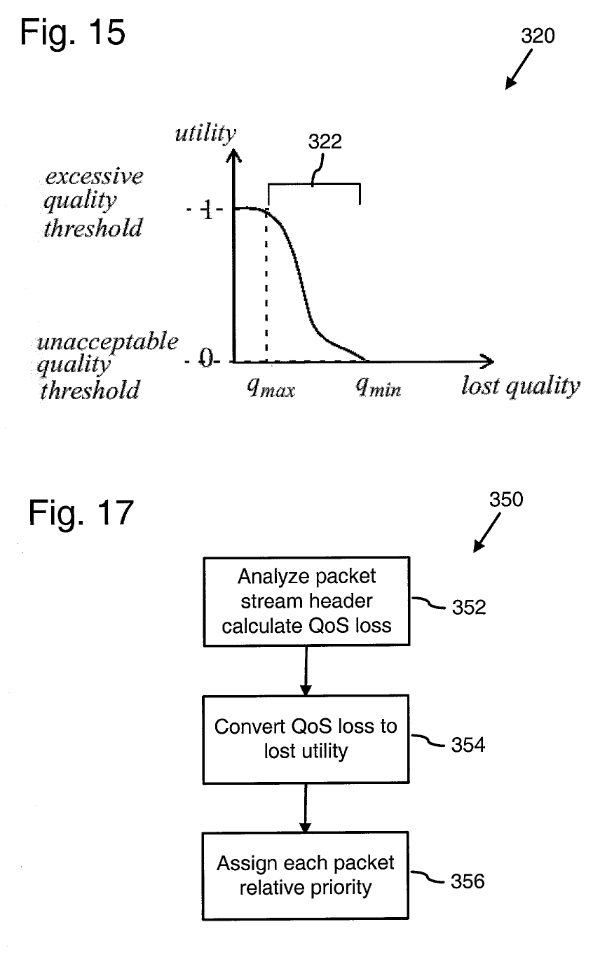

FIG. 15 is a graph 320 illustrating a general form of a utility function for providing a simple and general means for users to specify their preferences. The horizontal axis represents an objective measure of lost quality, and the vertical axis represents a subjective utility of a presentation at each quality level. A region 322 between lost quality thresholds qmax and qmin corresponds to acceptable presentation quality.

The qmax threshold marks the point where lost quality is so small that the user considers the presentation “as good as perfect.” The area to the left of this threshold, even if technically feasible, brings no additional value to the user. The rightmost threshold qmin marks the point where lost quality has exceeded what the user can tolerate, and the presentation is no longer of any use.

The utility levels on the vertical axis are normalized so that zero and one correspond to the “useless” and “as good as perfect” thresholds. In the acceptable region 322 of the presentation, the utility function should be continuous and monotonically decreasing, reflecting the notion that decreased quality should correspond to decreased utility.

Utility functions such as that represented by graph 320 are declarative in that they do not directly specify how to deliver a presentation. In particular, such utility functions do not require that the user have any knowledge of resource-QoS trade-offs. Furthermore, such utility functions represent the adaptation space in an idealized continuous form, even though QoS scalability mechanisms can often only make discrete adjustments in quality. By using utility functions to capture user preferences, this declarative approach avoids commitment to resource QoS and low-level adaptation decisions, leaving more flexibility to deal with the heterogeneity and load-variations of a best-effort environment such as the Internet.

FIGS. 14A and 14B are respective graphs 330 and 340 of exemplary utility functions for temporal resolution and spatial resolution in video, respectively. Graphs 330 and 340 illustrate that a utility function can be specified for each presentation-QoS dimension over which the system allows control. The temporal resolution utility function of graph 330 has its qmax threshold at 30 frames per second (fps), which corresponds to zero loss for a typical digital video encoding. The qmin threshold for the temporal resolution utility function of graph 330 is indicated at 5 fps, indicating that a presentation with any less temporal resolution would be considered unusable.

The spatial resolution utility function of graph 340 is expressed in terms of signal-to-noise ratio (SNR) in units of decibels (dB). The SNR is a commonly used measurement for objectively rating image quality. The spatial resolution utility function of graph 340 has its qmax threshold at 56 dB, which corresponds to zero loss for a typical digital video encoding. The qmin threshold for the spatial resolution utility function of graph 340 is indicated at 32 dB, indicating that a presentation with any less spatial resolution would be considered unusable.

QoS Mapper

FIG. 17 is a flow diagram of a QoS mapping method 350 for translating presentation QoS requirements, in the form of utility functions, into priority assignments for packets of a media stream, such as SPEG. QoS mapping method 350 is performed, for example, by quality of service mapper 114. In one implementation, quality of service mapper 114 performs QoS mapping method 350 dynamically as part of the streamed-media delivery pipeline; works on multiple QoS dimensions; and does not require a priori knowledge of the presentation to be delivered.

QoS mapping method 350 operates based upon assumptions about several characteristics of the media formats being processed. A first assumption is that data for orthogonal quality dimensions are in separate packets. A second assumption is that the presentation QoS, in each available dimension, can be computed or approximated for sub-sequences of packets. A third assumption is that any media-specific packet dependencies are known.

In one implementation, an SPEG stream is fragmented into packets in a way that ensures these assumptions hold. The packet format used for SPEG is based on an RTP format for MPEG video, as known in the art, with additional header bits to describe the SPEG spatial resolution layer of each packet. This approach is an instance of application-level framing.

This format provides that each packet contains data for exactly one SPEG layer of one frame, which ensures that the first assumption above for the mapper holds. Further, the packet header bits convey sufficient information to compute presentation QoS of sequences of packets and to describe inter-packet dependencies, thereby satisfying the second and third assumptions. Since all the information needed by the mapper is contained in packet headers, the mapping algorithm need not do any parsing or processing on the raw data of the video stream, which limits the computational cost of mapping.

QoS mapping method 350 determines a priority for each packet as follows.

Process block 352 indicates that a packet header is analyzed and a prospective presentation QoS loss is computed corresponding to the packet being dropped. The prospective presentation QoS loss computation is done for each QoS dimension.

Process block 354 indicates that the prospective presentation QoS loss is converted into lost utility based upon the predefined utility functions.

Process block 356 indicates that each packet is assigned a relative priority. In one implementation, each packet may be assigned its priority relative to other packets based upon the contribution to lost utility that would result from that packet (and all data that depends on it) being dropped.

QoS Mapping Example

Set forth below is a description of a quality of service (QoS) mapping example. The example relates to an input SPEG-format movie based upon the following group of pictures (GoP) pattern:

1₀B₁B₂B₃P₄B₅B₆B₇

The letter I, P, or B denotes the MPEG frame type, and the subscript is the frame number. For this example, it is assumed that the SPEG packet sequence includes four packets for each frame, one for each of four SNR layers supported by SPEG. For each packet in the sequence, the top-level of the mapper 114 calls subroutines that compute the lost presentation QoS in each dimension that would result if that packet was dropped.

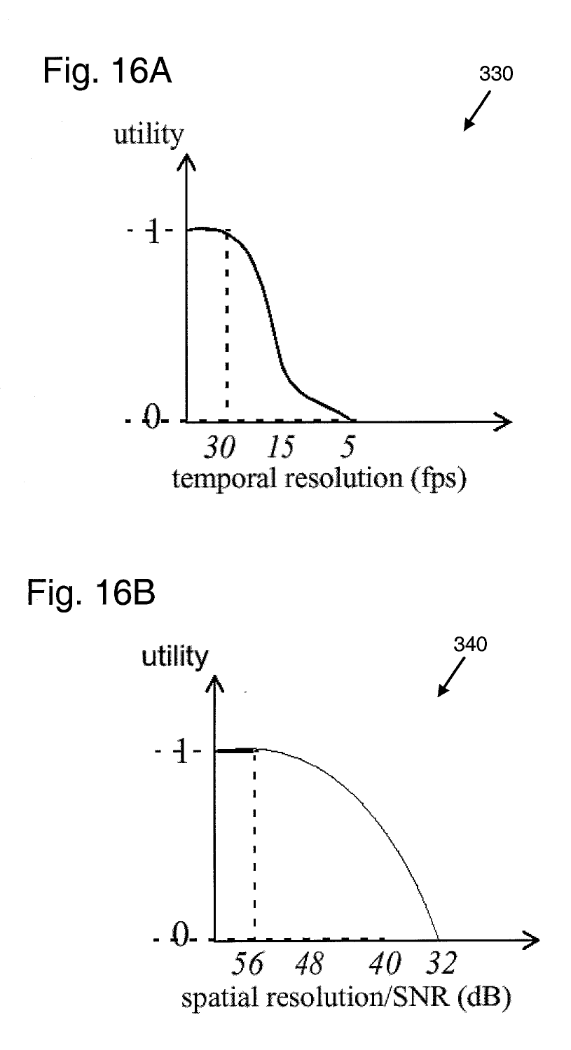

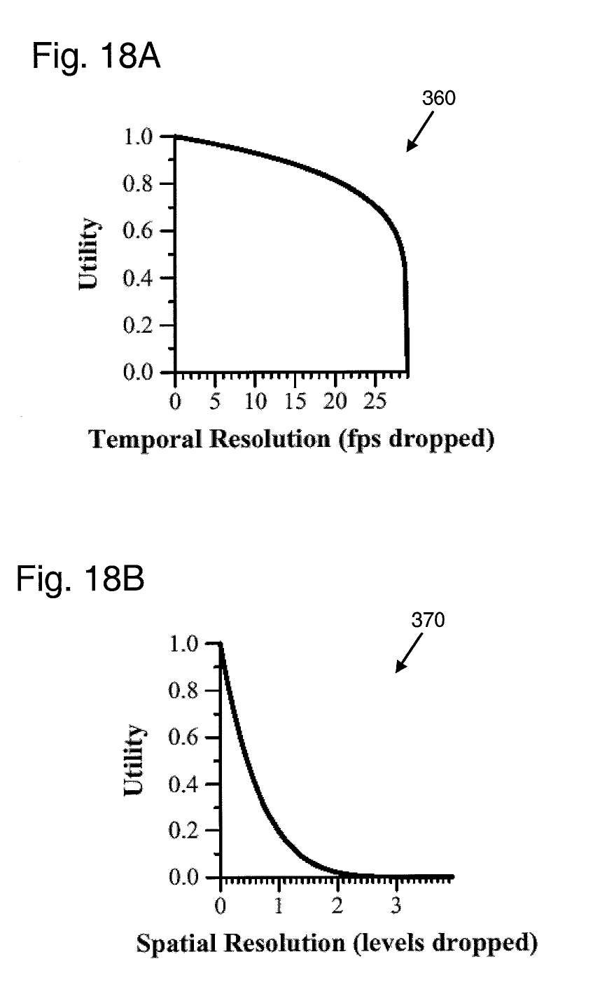

FIGS. 16A and 16B are respective graphs 360 and 370 of exemplary utility functions for temporal resolution and spatial resolution in video, respectively. Graphs 360 and 370 represent application of non-even bias to the utility functions to give spatial resolution more importance than temporal resolution, as indicated by the differing slopes of the two graphs.

For the temporal resolution dimension represented by graph 360, a lost QoS subroutine groups packets by frame and works by assigning a frame drop ordering to the sequence of frames. This process uses a simple heuristic to pick an order of frames that minimizes the jitter effects of dropped frames. The ordering heuristic is aware of the frame dependency rules of SPEG. For example, the ordering always ensures that a B (bi-directional) frame is dropped before the I or P frames that it depends on. In the exemplary packet sequence, the drop ordering chosen by the heuristic is:

B₁B₅<B₃B₇<B₂B₆<P₄<I₀

where <denotes the dropped-before relationship.

With this ordering, the frame rate of each packet is computed according to its frame's position in the ordering. The packets of frame B1 are assigned a reduced frame-rate value of (⅛×30), since frame B1 is the first frame dropped, and a frame rate of 30 fps is assumed. Frame P4 is assigned a reduced frame rate value of (⅞×30) since it is the second-to-last frame that is dropped. Notice that the lost QoS value is cumulative—it counts lost QoS from dropping the packet under consideration, plus all the packets dropped earlier in the ordering. These cumulative lost-QoS values are in the same units as the utility function's horizontal axis.

For the spatial resolution dimension, the lost QoS calculation is similar. Rather than computing ordering among frames, packets are grouped first by SNR level and then sub-ordered by an even-spacing heuristic similar to the one used for temporal resolution. As a simplification, the spatial QoS loss for each packet is approximated by a function based on the average number of SNR levels, rather than the actual SNR value, present in each frame when the packet is dropped.

The mapper applies the utility functions from the user's quality specification to convert lost-QoS values of packets into cumulative lost-utility values. The final step is to combine the lost-utilities in the individual dimensions into an overall lost-utility that is the basis for the packet's priority. The priority is assigned as follows: If in all quality dimensions the cumulative lost utility is zero, assign minimum priority. If in any quality dimension the cumulative lost utility is one, assign maximum priority. Otherwise, scale the maximum of the cumulative lost dimensional utilities into a priority in the range [minimum priority +1, maximum priority −1].

Minimum priority is reserved for packets that should never pass, because the cumulative lost utility of the packet does not cause quality to fall below the qmax threshold. Hence the quality level does not enter the excessive region of the utility function. Similarly, the maximum priority is reserved for packets that should always pass since in at least one of the quality dimensions, dropping the packet would cause quality to drop below the qmin threshold. So in one or more dimensions, dropping the packet would cause the presentation to become useless.

Sample Priority Progress Modules

The upstream adaptation buffer 182, downstream adaptation buffer 184, and progress regulator 188 of priority progress control mechanism 180 (FIG. 4) may be implemented with software instructions that are stored on computer readable media. In one implementation, the software instructions may be configured as discrete software routines or modules, which are described with reference to FIG. 9 and the generalized description of the operation of progress regulator 188.

Upstream adaptation buffer 182 may be characterized as including two routines or modules: PPS-UP-PUSH and PPS-UP-ADVANCE. These upstream priority-progress modules sort SDUs from timestamp order into priority order, push them through the bottleneck 186 as fast as it will allow, and discard unsent SDUs when progress regulator 188 directs upstream adaptation buffer 182 to advance the time window.

When the bottleneck 186 is ready to accept an SDU, an outer event loop will invoke PPS-UP-PUSH, which may be represented as:

PPS-UP-PUSH( )

1 sdu=HEAP-DELETE-MIN(upstream_reorder)

2 PUT(sdu)

3 if HEAP-EMPTY(upstream reorder)

4 then PAUSE−OUTPUT( )

PPS-UP-PUSH functions to remove the next SDU, in priority order, from the heap (line 1), and write the SDU to the bottleneck 186 (line 2). In the normal case, when maximum bandwidth requirements of the stream exceed the capacity of the bottleneck 186, the HEAP-EMPTY condition at line 3 will never be true, because progress regulator 188 will invoke PPS-UP-ADVANCE before it can happen. For simplicity, it is assumed that if line 3 does evaluate true, then streaming is suspended (line 4), waiting for the PPS-UP-ADVANCE to resume.

The routine or module PPS-UP-ADVANCE is called periodically by progress regulator 188 as it manages the timeline of the streaming media (e.g., video). The purpose of PPS-UP-ADVANCE is to advance from a previous time window position to a new position, defined by the window_start and window_end time parameters. PPS-UP-ADVANCE may be represented as:

PPS-UP-ADVANCE(window_start; window_end)

1 while not HEAP-EMPTY(up_reorder)

2 do sdu←HEAP-DELETE-MIN(up_reorder)

3 if priority[sdu]<max_priority

4 then DISCARD(sdu)

5 else PUT(sdu)

6 sdu←PEEK( )

7 while timestamp[sdu]<window_end

8 do sdu←GET( )

9 deadline[sdu]←window_start

10 HEAP-INSERT(up_reorder, priority[sdu], sdu)

11 sdu←PEEK( )

12 RESUME-OUTPUT( )

The first loop in lines 1-5 drains the remaining contents of the previous window from the heap. Normally, the still-unsent SDUs from the previous window are discarded (line 4), however a special case exists for maximum priority SDUs (line 5). In this implementation, maximum priority SDUs are never dropped. It has been determined that providing a small amount of guaranteed service helps greatly to minimize the amount of required error detection code in video software components.

SDUs are also marked corresponding to the minimal acceptable quality levels with maximum priority. Hence, the case where a maximum priority SDU is still present in the up reorder heap (line 5) represents a failure of the bottleneck 186 to provide enough throughput for the video to sustain the minimum acceptable quality level. An alternative choice for line 5 would be to suspend streaming and issue an error message to the user.

After the heap has been drained of remaining SDUs from the old window position, the heap is filled with new SDUs having timestamps in the range of the new window position. Window positions are strictly adjacent, that is window_start of the new window equals window_end of the previous window. Therefore, each SDU of the video will fit uniquely into one window position. The loop of lines 7-11 does the filling of the heap. In particular, line 9 assigns the value window_start to a deadline attribute of each SDU. The deadline attribute is used in compensating for the end-to-end delay through the bottleneck 186.

Downstream adaptation buffer 184 may be implemented with a variety of modules or routines. For example, PPS-DOWN-PULL is invoked for each SDU that arrives from the bottleneck 186. The difference between the current play time and the deadline SDU attribute is used to check whether the SDU has arrived on time (lines 1-2). In normal conditions the SDU arrives on time and is entered into the down reorder heap (line 3). Additionally, the deadline attribute is compared to determine if the SDU is the first of a new window position, and if so PPS-Down-Push is scheduled for execution at the new deadline (lines 4-6).

PPS-DOWN-PULL(sdu)

1 new_window=deadline[sdu]>downstream_deadline

2 if new_window

3 then window_phase 0

4 overrun=PPS-DOWN-GET-TIME( )_deadline[sdu]

5 if overrun<=0

6 then HEAP-INSERT(down_reorder; timestamp[sdu]; sdu)

7 if new window

8 then down_deadline←deadline[sdu]

9 SCHEDULE-CALLBACK(down_deadline; PPS-DOWN-PUSH)

10 else PPS-DOWN-LATE(sdu; overrun)

The scheduling logic described above causes a PPS-DOWN-PUSH routine to be called whenever the timeline crosses a position corresponding to the start of a new window. PPS-DOWN-PUSH has a loop that drains the down_reorder heap, forwarding the SDUs in timestamp order for display.

PPS-DOWN-PUSH( )

1 while not HEAP-EMPTY(down_reorder)

2 do PUT(HEAP-DELETE-MIN(down_reorder))

In the case where an SDU arrives later than its deadline (line 10 of PPS-DOWN-PULL), a PPS-DOWN-LATE routine is called. PPS-DOWN-LATE deals with the late SDU (lines 1-3) in the same manner described above for PPS-UP-PUSH. Late SDUs are dropped with a special case for maximum priority SDUs. The amount of tardiness is also tracked and passed on to progress regulator 188 (lines 4-6), so that it may adjust the timing of future window positions so as to avoid further late SDUs.

PPS-DOWN-LATE(sdu; overrun)

1 if priority[sdu]<max_priority

2 then DISCARD(sdu)

3 else PUT(sdu)

4 if window_phase <overrun

5 then PPS-REG-PHASE-ADJUST (overrun-window_phase)

6 window_phase←overrun

Progress regulator 186 may also be implemented with modules or routines that manage the size and position of the reorder or adaptation window. The modules for the progress regulator 186 attempt to prevent late SDUs by phase-adjusting the downstream and upstream timelines relative to each other, where the phase offset is based on a maximum observed end-to-end delay. Usually, late SDUs only occur during the first few window positions after startup, as the progress regulator 186 is still discovering the correct phase adjustment.

A PPS-REG-INIT routine initializes the timelines (lines 1-4) and invokes PPS-REG-ADVANCE to initiate the streaming process. Logically, there are two clock components in priority progress streaming, a regulator clock within regulator 188 is used to manage the timeline of the upstream window and a downstream clock in downstream adaptation buffer 184 drives the downstream window.

PPS-REG-INIT(start pos; min win size; max win size; min phase)

1 win_size←min_win_size

2 reg_phase_of f set←min_rtt

3 clock_start←start_pos _min_size

4 PPS-REG-SET-CLOCK(clock_start)

5 PPS-DOWN-SET-CLOCK(clock_start)

6 PPS-REG-ADVANCE(start_pos)

PPS-REG-INIT expects the following four parameters. The first is start_pos, a timestamp of the start position within the video segment. For video-on-demand, the start position would be zero. A new webcast session would inherit a start position based on wallclock or real world time. Size parameters min_win_size and max_win_size set respective minimum and maximum limits on the reorder window size.

It is noted that the clocks are initialized to the start position minus the initial window size (line 1). This establishes a prefix period with a duration equal to the initial window size and during which SDUs will be streamed downstream but not forwarded to the display. A min_phase is an estimate of a minimum phase offset. If min_phase is zero, then late SDUs are guaranteed to occur for the first window position, because of the propagation delay through the bottleneck 186. The min_phase parameter is usually set to some small positive value to avoid some of the late SDUs on startup.

In implementations in which the regulator module is part of the client, interactions between the regulator and the server are remote. Otherwise, if the regulator is part of the server, the interactions between the regulator and client are remote. The phase adjustment logic in priority-progress streaming will compensate for delay of remote interactions in either case. In one implementation, remote interactions are multiplexed into the same TCP session as the SDUs.

The main work of the progress regulator 188 is performed by a PPS-REG-ADVANCE routine. The logical size of the adaptation window is set, adjusting by win_scale_ratio, but kept within the range of minimum and maximum window sizes (line 1). A win_start parameter is a time position of the beginning of the new window position, which is the same as the end position of the previous position for all positions after the first (line 5). Calling of the PPS-UP-ADVANCE routine causes the server 182 to discard unsent SDUs from the previous window position and commence sending SDUs of the new position (line 4).

PPS-REG-ADVANCE(win_start)

1 win_size←Clamp(win_size x win_scale_ratio, min_win_size, max_win_size)

2 win_end←win_start+win_size

3 PPS-UP-ADVANCE(win_start, win_end)

4 reg_deadline←win_start-reg_phase_of f set

5 reg_timeout←SCHEDULE-CALLBACK(reg-deadline, PPS-REG-ADVANCE; win_end)

The following example illustrates operation of the progress regulator 188 with respect to the PPS-REG-INIT and the PPS-UP-ADVANCE routines. For the prefix, start_pos is 0, min_win_size is 1, max_win_size is 10, and win_scale_ratio is 2. For simplicity it is assumed that that min_phase and end-to-end delay are 0. Stepping through the PPS-UP-ADVANCE routine results in the following.

The initial window size is 1 and the initial value of clocks will be −1 (lines 1-3 of PPS-REG-INIT). The advertised window size in PPS-REG-ADVANCE will actually be 2, and the first pair of values (win_start, win_end) will be (0, 2) (lines 1-3 of PPS-REG-ADVANCE). The deadline will be set to 0 (line 4 of PPS-REG-INIT).

At 1 time unit in the future the value of the regulator clock will reach 0 and the PPS-REG-ADVANCE routine is called with parameter value 2. During the 1 time unit that passed, SDUs were sent from upstream to downstream in priority order for the timestamp interval (0; 2). Since the display will consume SDUs in real-time relative to the timestamps, an excess of 1 time unit worth of SDUs will be accumulated at the downstream buffer. This process will continue for each successive window, each interval ending with excess accumulation equal to half the advertised window size.

In this example the sequence of advertised window sizes forms a geometric series

2+4+::: 2ⁿ⁺¹=(rⁿ−a)/(r−1)

where r=2 and a =2. In each interval, one-half of the bandwidth is “skimmed” so the window could increase by a factor of 2 in the next interval. The effect of the deadline window logic is to advance the timeline at a rate that equals the factor win_scale_ratio times real-time.

In Priority-Progress streaming, quality changes will occur at most twice per window position. Larger window sizes imply fewer window positions and hence fewer quality changes. However larger window sizes require longer startup times. Window scaling allows starting with a small window, yielding a short startup time, but increasing the size of window after play starts. The sequence above illustrates that the number of positions, and hence the number of quality changes, is bounded as follows:

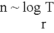

where T is the duration of the video (2+4+:::2\hat{ }(n+1)), and r is the win_scale_ratio. If r>1, n grows more slowly as T gets larger: the longer the duration T, the more stable on average that quality becomes, irrespective of dynamic variations in system and network loads.

As described with reference to the PPS-DOWN-LATE routine, the PPS-REG-PHASE-ADJUST routine is called when SDUs arrive late downstream. To prevent further late SDUs, the regulator timeout is rescheduled to occur earlier by an amount equal to the tardiness of late SDU. For a priority progress streaming session, while the IP route between server and client remains stable, the end-to-end delay through TCP will tend to plateau. When this delay plateau is reached, the total phase offset accumulated through invocations of PPS-REG-PHASE-ADJUST also plateaus.

PPS-REG-PHASE-ADJUST(adjust)

1 reg_deadline←reg_deadline-adjust

2 reg_phase←reg_phase+adjust

3 reg_timeout←RESCHEDULE-CALLBACK(reg_timeout, reg_deadline)

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A computer-based priority progress media-streaming system for providing quality-adaptive transmission of a multimedia presentation over a shared heterogeneous computer network, comprising:
a server-side streaming media pipeline that transmits a stream of media packets that include time stamps and encompass the multimedia presentation, ones of the media packets corresponding to a segment of the multimedia presentation being transmitted based upon packet priority labeling out of time sequence from other media packets corresponding to the segment; and
a client side streaming media pipeline that receives the stream of media packets, orders them in time sequence according to the time stamps, and renders the multimedia presentation from the ordered media packets.

2. The system of claim 1 in which all media packets corresponding to the segment are transmitted based upon the packet priority labeling, with higher priority media packets being transmitted before lower priority media packets.

3. The system of claim 1 in which fewer than all media packets corresponding to the segment of the multimedia presentation are transmitted, the media packets that are transmitted being of higher priority than the media packets that are not transmitted.

4. The system of claim 3 further comprising a transmission capacity that reflects a dynamic capacity to transmit and render the media packets, the priorities of the media packets that are transmitted being dynamically adapted to conform to the transmission capacity.

5. The system of claim 1 in which the server-side streaming media pipeline includes a priority progress transcoder that receives one or more conventional format media files and converts them into a corresponding stream of media packets.

6. The system of claim 5 in which the conventional format media files correspond to video media.

7. The system of claim 6 in which the conventional format media files correspond to a MPEG-format media file.

8. The system of claim 1 in which the server-side streaming media pipeline includes a quality of service (QoS) mapper that applies packet priority labeling to the media packets.

9. The system of claim 8 in which the server-side streaming media pipeline further includes a predefined quality of service (QoS) specification that is stored in computer memory and defines packet priority labeling criteria that are applied by the quality of service (QoS) mapper.

10. The system of claim 9 in which the predefined quality of service (QoS) specification defines packet priority labeling criteria corresponding to media temporal resolution.

11. The system of claim 9 in which the predefined quality of service (QoS) specification defines packet priority labeling criteria corresponding to a picture signal-to-noise ratio.

12. A priority progress media-streaming server system for providing quality-adaptive transmission of a multimedia presentation over a shared heterogeneous computer network, comprising:
a priority progress transcoder that receives one or more conventional format media files and converts them into a corresponding stream of layered media packets;
a quality of service (QoS) mapper that applies packet priority labeling to the layered media packets; and
a priority progress streamer that transmits the layered media packets as a stream that encompasses at least a portion of the multimedia presentation, ones of the media packets corresponding to a segment of the multimedia presentation being transmitted based upon packet priority labeling out of time sequence from other media packets corresponding to the segment.

13. The system of claim 12 in which further comprising a predefined quality of service (QoS) specification that is stored in computer memory and defines packet priority labeling criteria that are applied by the quality of service (QoS) mapper.

14. The system of claim 13 in which the predefined quality of service (QoS) specification defines packet priority labeling criteria corresponding to media temporal resolution.

15. The system of claim 13 in which the predefined quality of service (QoS) specification defines packet priority labeling criteria corresponding to a picture signal-to-noise ratio.

16. The system of claim 12 in which all media packets corresponding to the segment are transmitted based upon the packet priority labeling, with higher priority media packets being transmitted before lower priority media packets.

17. The system of claim 12 in which fewer than all media packets corresponding to the segment of the multimedia presentation are transmitted, the media packets that are transmitted being of higher priority than the media packets that are not transmitted.

18. The system of claim 17 further comprising a transmission capacity that reflects a dynamic capacity to transmit and render the media packets, the priorities of the media packets that are transmitted being dynamically adapted to conform to the transmission capacity.

19. The system of claim 12 in which the conventional format media files correspond to video media.

20. The system of claim 19 in which the conventional format media files correspond to a MPEG-format media file.

21. A priority progress media-streaming client system for providing quality-adaptive reception of a multimedia presentation over a shared heterogeneous computer network, comprising:
a priority progress client transcoder that receives a stream of media packets that encompass at least a portion the multimedia presentation, ones of the media packets corresponding to a segment of the multimedia presentation being transmitted based upon packet priority labeling out of time sequence from other media packets corresponding to the segment, the priority progress client transcoder ordering the received media packets in time sequence according to time stamps included in the media packets and rendering the multimedia presentation from the ordered media packets.

22. The system of claim 21 in which the priority progress client transcoder receives fewer than all media packets corresponding to the segment of the multimedia presentation, the media packets that are received being of higher priority than the media packets that are not received.

23. The system of claim 22 further comprising a transmission capacity that reflects a dynamic capacity for the priority progress client transcoder to receive and render the media packets, the priorities of the media packets that are transmitted being dynamically adapted to conform to the transmission capacity.

24. A computer-based priority progress data-streaming system for providing quality-adaptive transmission of a data stream over a shared heterogeneous computer network, comprising:
a server-side streaming data pipeline that transmits a stream of data packets that include time stamps and encompass the streaming data, ones of the data packets corresponding to a segment of the data stream being transmitted based upon packet priority labeling out of time sequence from other data packets corresponding to the segment; and
a client side streaming data pipeline that receives the stream of data packets and orders them in time sequence according to the time stamps.

25. The system of claim 24 in which all data packets corresponding to the segment are transmitted based upon the packet priority labeling, with higher priority data packets being transmitted before lower priority data packets.

26. The system of claim 24 in which fewer than all data packets corresponding to the segment of the data stream are transmitted, the data packets that are transmitted being of higher priority than the data packets that are not transmitted.

27. The system of claim 26 further comprising a transmission capacity that reflects a dynamic capacity to transmit the data packets, the priorities of the data packets that are transmitted being dynamically adapted to conform to the transmission capacity.

28. The system of claim 24 in which the server-side streaming data pipeline includes a priority progress transcoder that receives one or more conventional format data files and converts them into a corresponding scaleable stream of data packets.

29. The system of claim 28 in which the conventional format data files correspond to video media.

30. The system of claim 28 in which the conventional format data files correspond to sensor data.

31. The system of claim 24 in which the server-side streaming data pipeline includes a quality of service (QoS) mapper that applies packet priority labeling to the data packets.

32. The system of claim 31 in which the server-side streaming data pipeline further includes a predefined quality of service (QoS) specification that is stored in computer memory and defines packet priority labeling criteria that are applied by the quality of service (QoS) mapper.

33. A priority progress data-streaming client system for providing quality-adaptive reception of a data stream over a shared heterogeneous computer network, comprising:
a priority progress client transcoder that receives a stream of data packets that encompass at least a portion the data stream, ones of the data packets corresponding to a segment of the data stream being transmitted based upon packet priority labeling out of time sequence from other data packets corresponding to the segment, the priority progress client transcoder ordering the received data packets in time sequence according to time stamps included in the data packets.

34. The system of claim 33 in which the priority progress client transcoder receives fewer than all data packets corresponding to the segment of the data stream, the data packets that are received being of higher priority than the data packets that are not received.

35. The system of claim 34 further comprising a transmission capacity that reflects a dynamic capacity for the priority progress client transcoder to receive the data packets, the priorities of the data packets that are transmitted being dynamically adapted to conform to the transmission capacity.

36. In a computer readable medium, a priority progress data-streaming data structure for providing quality-adaptive transmission of a data stream over a shared heterogeneous computer network, comprising:
a stream of data packets that include time stamps and packet priority labels and that are arranged in an out-of-time-sequence according to the time stamps.
